(19) United States
(12) Patent Application Publication
(10) Pub. No.: US 2026/0298661 A1
(43) Pub. Date: Oct. 1, 2026

(54) METHOD FOR GENERATING A MAP REPRESENTATION FOR A VEHICLE

(71) Applicant: Robert Bosch GmbH, Stuttgart (DE)

(72) Inventors: Hans-Georg Raumer, Hildesheim (DE); Max Kirstein, Hohenhameln - Ot Bruendeln (DE); Thomas Wenzel, Hamburg (DE); Thorben Funke, Sarstedt (DE)

(21) Appl. No.: 19/574,800

(22) Filed: Mar. 23, 2026

(30) Foreign Application Priority Data
Mar. 31, 2025 (DE) 10 2025 112 421.3

(51) Int. Cl. G01C 21/00; G06V 10/80; G06V 10/82

(52) U.S. Cl. CPC G01C 21/3833; G01C 21/3807; G06V 10/806; G06V 10/82

(57) ABSTRACT

A computer-implemented method for generating a map representation for a vehicle. The method includes: receiving environmental sensor data of at least one environmental sensor of the vehicle by an onboard map generation system, the environmental sensor data at least partially representing the environment of the vehicle; receiving map data of an electronic road map by the on-board map generation system, the map data at least partially representing the traffic infrastructure within the environment of the vehicle, and the map data includes landmark information and/or planning information regarding average traffic behavior of road users in relation to the traffic infrastructure within the environment; and generating the map representation of the environment of the vehicle based on the environmental sensor data and the landmark information and/or planning information of the map data by the onboard map generation system, wherein the map representation includes the landmark information and/or planning information.

### CROSS REFERENCE

The present application claims the benefit under 35 U.S.C. § 119 of Germany Patent Application No. DE 10 2025 112 421.3 filed on Mar. 31, 2025, which is expressly incorporated herein by reference in its entirety.

### FIELD

The present disclosure relates to a method for generating a map representation for a vehicle.

### BACKGROUND INFORMATION

Certain methods for generating maps for vehicles are described in the related art.

It is an object of the present disclosure to provide an improved method for generating a map representation for a vehicle.

### SUMMARY

The object may be achieved by a method including certain features of the present application. Advantageous example embodiments are disclosed herein.

According to one aspect, a computer-implemented method for generating a map representation for a vehicle is provided. According to an example embodiment, the method comprises:
receiving environmental sensor data of at least one environmental sensor of the vehicle by an onboard map generation system,
wherein the environmental sensor data at least partially represent the environment of the vehicle;
receiving map data of an electronic road map by the onboard map generation system, wherein the map data at least partially represent the traffic infrastructure within the environment of the vehicle, and wherein the map data comprise landmark information and/or planning information regarding average traffic behavior of road users in relation to the traffic infrastructure within the environment of the vehicle; and
generating a map representation of the environment of the vehicle on the basis of the environmental sensor data and the landmark information and/or planning information of the map data by the onboard map generation system, wherein the map representation comprises the landmark information and/or planning information.

This can achieve the technical advantage that an improved method for generating a map representation for a vehicle can be provided. The map representation is generated by an onboard map generation system on the basis of environmental sensor data of at least one environmental sensor of the vehicle. The map representation is thus created during operation of the vehicle by the onboard map generation system implemented in the vehicle.

In addition to the environmental sensor data which at least partially represent the environment of the vehicle, the onboard map generation system also takes into account map data of an electronic road map for map creation. The electronic road map represents the traffic infrastructure of the environment of the vehicle and comprises landmark information and/or planning information.

Landmark information and/or planning information, within the meaning of the application, refers to information about clearly identifiable landmarks within the environment of the vehicle, or information that can be taken into account in the movement planning for the vehicle.

On the basis of the environmental sensor data which represent a current state of the environment of the vehicle, and taking into account the map data of the road map which are based on historical data and at least partially represent the traffic infra-structure within the environment of the vehicle, the map representation is subsequently generated by the onboard map generation system. In this case, the map representation comprises at least the landmark information and/or planning information of the road map.

The map representation, within the meaning of the present application, is a map of the environment of the vehicle that is generated by the onboard map generation system executing an onboard map generation (OMG). The map representation represents the current state of the environment of the vehicle and comprises information based on the environmental sensor data of the at least one environmental sensor and is expanded by information from the electronic road map, in particular the landmark information and/or planning information.

By taking into account the landmark information and/or planning information from the electronic road map, the method according to the present disclosure can provide an improved map representation of the environment of the vehicle during operation of the vehicle, which is expanded by the landmark information and/or planning information from the electronic road map.

Here, the electronic road map serves as a map prior, as is conventional for onboard map generation systems.

According to one example embodiment, the landmark information and/or planning information comprise at least one item of sub-information from the following list: traffic sign, road marking, center line, segment information.

As a result, the technical advantage can be achieved that the map representation generated by the onboard map generation system can be expanded by relevant information through the corresponding landmark information and/or planning information, which enables precise orientation of the vehicle and/or precise trajectory planning of the vehicle based on the information in the map representation.

According to one example embodiment, the environmental sensor data comprise image data and/or video data, and/or wherein the method further comprises:
converting the environmental sensor data into bird's-eye-view features by a transformer of a BEV backbone of the onboard map generation system;
extracting map features on the basis of the bird's-eye-view features by a map head of the onboard map generation system; and generating the map representation on the basis of the map features by a map prediction module of the onboard map generation system.

As a result, the technical advantage can be achieved that a map representation can be precisely generated by the onboard map generation system on the basis of the image data and/or video data of the environmental sensors.

According to one example embodiment, the method further comprises:
generating feature vectors on the basis of the landmark information and/or planning information of the map data by a map encoder of the onboard map generation system; and
fusing the feature vectors with the environmental sensor data.

As a result, the technical advantage can be achieved that, by generating the feature vectors on the basis of the landmark information and/or planning information of the electronic road map, a precise fusion of the corresponding landmark information and/or planning information with the environmental sensor data is made possible.

By fusing the correspondingly converted landmark information and/or planning information with the environmental sensor data, an improved integration of the landmark information and/or planning information into the map representation generated on the basis of the environmental sensor data is made possible.

In this case, the fusion of the corresponding feature vectors with the environmental sensor data can take place at different times during the processing of the environmental sensor data provided by the environmental sensors by the onboard map generation system.

In this case, the fusion of the feature vectors with the environmental sensor data is not intended to be limited to the pure environmental sensor data as provided by the environmental sensors. A fusion can also take place with the BEV features of the environmental sensor data or at an even later processing time.

According to one example embodiment, the fusion of the feature vectors with the environmental sensor data takes place in the map head, and/or wherein the fusion is effected via a cross-attention mechanism between the feature vectors and the BEV features of the environmental sensor data, and/or wherein the fusion of the feature vectors with the environmental sensor data takes place in the transformer of the BEV backbone, and/or wherein the feature vectors are fused with the BEV features generated by the BEV backbone via a cross-attention mechanism.

As a result, the technical advantage can be achieved that, by fusing the feature vectors with the environmental sensor data in the map head, a fusion of the feature vectors with the environmental sensor data that takes place as late as possible in the processing chain of the environmental sensor data is made possible. As a result, it can be achieved that previous processing steps of the environmental sensor data remain unaffected by the fusion with the feature vectors of the landmark information and/or planning information.

By running the cross-attention mechanism to fuse the feature vectors with the BEV features of the environmental sensor data, a precise fusion can be achieved. By fusing the feature vectors with the environmental sensor data within a transformer of a BEV backbone in order to convert the environmental sensor data into the BEV features, it can be achieved that the feature vectors can be directly integrated into the BEV features to be generated on the basis of the environmental sensor data.

According to one example embodiment, the generation of the feature vectors comprises:
generating a sub-feature vector for each of the items of sub-information of the landmark information and/or planning information; and
merging the sub-feature vectors to form a total feature vector by the map encoder.

This can achieve the technical advantage that, by generating the sub-feature vectors for each item of sub-information of the landmark information and/or planning information and by subsequently concatenating the plurality of sub-feature vectors into common feature vectors, a representation of the landmark information and/or planning information of the road map in vector form that is as precise as possible is made possible.

According to one example embodiment, the map encoder comprises a plurality of artificial subnetworks and generative neural networks, wherein each subnetwork and generative neural network is configured to generate a corresponding sub-feature vector on the basis of the map data for an item of sub-information of the landmark information and/or planning information.

As a result, the technical advantage can be achieved that precise sub-feature vectors can be generated by the artificial sub-networks and generative neural networks of the map encoder on the basis of the various items of sub-information of the landmark information and/or planning information. By virtue of the correspondingly trained artificial intelligences, each item of sub-information of the landmark information and/or planning information of the electronic road map can be taken into account individually.

According to one example embodiment, the road marking and the center line are each configured as line information, wherein the traffic sign is configured as point information, and wherein the generation of the sub-feature vectors comprises:
representing the line information as a plurality of items of point information and generating the sub-feature vectors as multidimensional vectors, wherein the dimension of a sub-feature vector corresponds to a sum of a number of items of point information and a number of features of the particular item of sub-information;
parameterizing relationships between segments and/or parameterizing relationships between traffic signs and/or lanes and/or between center lines by adjacency matrices;
generating the sub-feature vector on the basis of the parameterizations by a generative neural network.

This can achieve the technical advantage that a precise representation of the landmark information and/or planning information in the form of the feature vectors is made possible.

According to one aspect, a computing unit is provided that is configured to carry out the method according to one of the above-described embodiments for generating a map representation for a vehicle.

According to one aspect, a computer program product is provided which comprises commands that, when the program is executed by a data processing unit, cause the data processing unit to carry out the method according to one of the above-described embodiments for generating a map representation for a vehicle.

Example embodiments of the present disclosure are described with reference to the figures.

### BRIEF DESCRIPTION OF THE DRAWINGS

FIG. 1 is a graphical representation of an onboard map generation system for generating a map representation for a vehicle according to one example embodiment.

FIG. 2 is a graphical representation of map information for the onboard map generation system for generating the map representation according to a further example embodiment.

FIG. 3 is a schematic representation of a map encoder of the on-board map generation system according to one example embodiment.

FIG. 4 is a flowchart of a method for generating a map representation for a vehicle according to a further example embodiment.

FIG. 5 is a further flowchart of a method for generating a map representation for a vehicle according to a further example embodiment.

FIG. 6 is a schematic representation of a computer program product.

### DETAILED DESCRIPTION OF EXAMPLE EMBODIMENTS

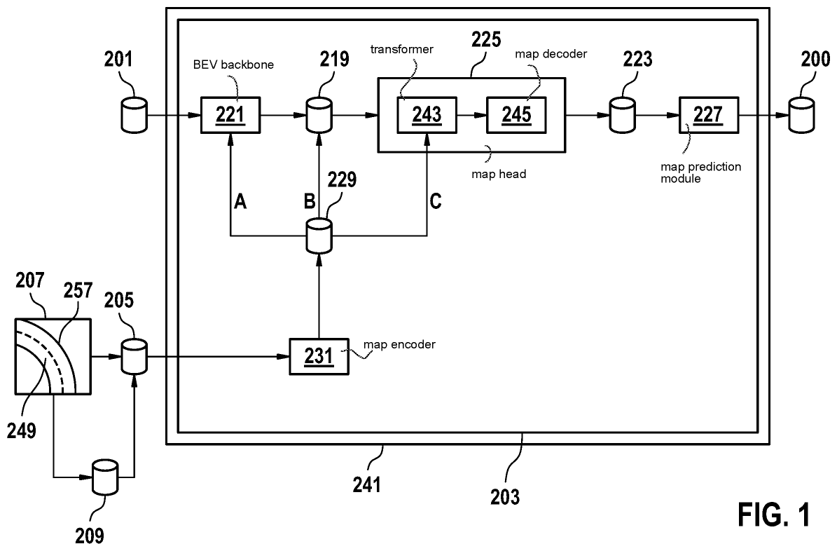

FIG. 1 is a graphical representation of an onboard map generation system 203 for generating a map representation 200 for a vehicle according to one example embodiment.

According to the present disclosure, the onboard map generation system 203 is configured to generate a map representation 200 of the environment of the vehicle on the basis of environmental sensor data 201 of at least one environmental sensor of the vehicle and map data 205 of an electronic road map 207.

In this case, the map data 205 comprise at least landmark information and/or planning information 209 of the electronic road map 207. The landmark information and/or planning information 209 are taken into account in the onboard map generation of the map representation 200 so that the map representation 200 after generation comprises the landmark information and/or planning information 209 of the electronic road map 207.

The electronic road map 207 is based on historical data, which are based, for example, on historical trips by a plurality of different vehicles and on the environmental sensor data of the respective vehicles recorded during the trips. The electronic road map 207 thus represents a mapping of traffic infrastructure. According to the present disclosure, the electronic road map 207 comprises the aforementioned landmark information and/or planning information 209.

The landmark information and/or planning information 209 comprise information regarding perceptible landmarks and/or regarding other features of the traffic infrastructure that can be taken into account when planning the trajectory of the vehicle.

According to one embodiment, the landmark information and/or planning information 209 comprise at least one item of sub-information from the following list: traffic sign 211, road marking 213, center line 215, segment information 217.

According to one embodiment, the environmental sensor data 201 comprise image data and/or video data.

In the embodiment shown, the onboard map generation system 203 comprises a BEV backbone 221. The BEV backbone 221 is configured to convert the environmental sensor data 201 into BEV features 219, i.e. into bird's-eye-view features.

In the embodiment shown, the onboard map generation system 203 further comprises a map head 225 having a transformer 243 and a map decoder 245. In this case, the map head 225 is configured to generate map features 223 on the basis of the BEV features 219 of the environmental sensor data 201.

In the embodiment shown, the onboard map generation system 203 further comprises a map prediction module 227. In this case, the map prediction module 227 is configured to generate the map representation 200 on the basis of the map features 223.

In the embodiment shown, the onboard map generation system 203 further comprises a map encoder 231. In this case, the map encoder 231 is configured to generate feature vectors 229 on the basis of the map data 205 of the electronic road map 207 and the comprised landmark information and/or planning information 209. In this case, the feature vectors 229 are in the form of multi-dimensional vectors and comprise the information of the map data 205, in particular the landmark information and/or planning information 209.

In order to integrate the landmark information and/or planning information 209 of the electronic road map 207, the onboard map generation system 203 is configured to fuse the feature vectors 229 with the environmental sensor data 201.

In this case, the electronic road map 207 serves as a map prior, as is conventional for onboard map generation systems.

FIG. 1 shows three different fusion alternatives A, B, C.

In fusion variant A, the feature vectors 229 representing the landmark information and/or planning information 209 are fused with the environmental sensor data 201 within the BEV backbone 221.

The fusion of the environmental sensor data 201 with the feature vectors 229 within the BEV backbone 221 can be carried out analogously to Luo et al. (K. Z. Luo, X. Weng, Y. Wang, S. Wu, J. Li, K. Q. Weinberger, Y. Wang, and M. Pavone, “Augmenting lane perception and topology understanding with standard definition navigation maps,” in 2024 IEEE International Conference on Robotics and Automation (ICRA), pp. 4029-4035, IEEE, 2024).

In fusion variant B, the feature vectors 229 are directly fused with the BEV features 219 of the environmental sensor data 201.

The fusion of the feature vectors 229 with the BEV features 219 can be carried out analogously to Wu et al. (H. Wu, Z. Zhang, S. Lin, T. Qin, J. Pan, Q. Zhao, C. Xu, and M. Yang, “Blos-bev: Navigation map enhanced lane segmentation network, beyond line of sight,” in 2024 IEEE Intelligent Vehicles Symposium (IV), pp. 3212-3219, IEEE, 2024).

In fusion variant C, the feature vectors 229 are fused with the environmental sensor data 201 within the transformer 243 of the map head 225. The fusion of the feature vectors 229 with the environmental sensor data 201 within the transformer 243 of the map head 225 can be carried out by means of a cross-attention mechanism.

According to one embodiment, the transformation of the environmental sensor data 201 into the BEV features 219 by the BEV backbone 221 takes place analogously to Yang et al. (C. Yang, Y. Chen, H. Tian, C. Tao, X. Zhu, Z. Zhang, G. Huang, H. Li, Y. Qiao, L. Lu, et al., “Bevformer v2: Adapting modern image back-bones to bird's-eye-view recognition via perspective supervision,” in Proceedings of the IEEE/CVF Conference on Computer Vision and Pattern Recognition, pp. 17830-17839, 2023).

In FIG. 1, the onboard map generation system 203 is shown to be executable on a computing unit 241.

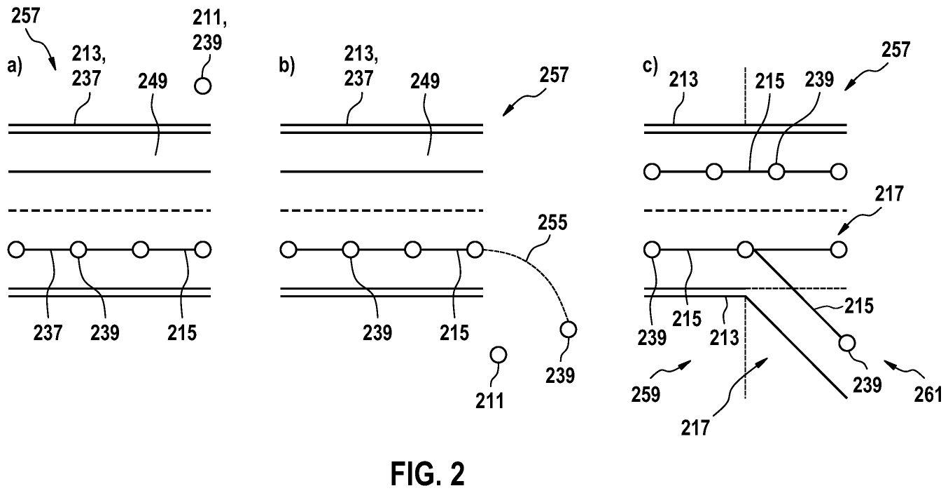

FIG. 2 shows graphical representations of map information for the onboard map generation system 203 for generating the map representation 200 according to a further embodiment.

In graphics a) to c), various items of sub-information of the landmark information and/or planning information 209 are graphi-cally represented as an extract from the electronic road map 207.

Graphics a) to c) each show a road 257 with two lanes 249. The road 257 is provided with road markings 213. The road markings 213 each serve as items of sub-information of the landmark information and/or planning information 209. The road markings 213 are shown in graphics a) to c) as line information 237.

Line information 237 is to be understood, within the meaning of the application, as continuous lines or line segments.

In graphic a), a traffic sign 211 is also shown as an item of sub-information of the landmark information and/or planning information 209. The traffic sign 211 in the form of a road sign is shown in graphic a) as point information 239.

Point information 239 is to be understood, within the meaning of the application, as point-like representations.

Furthermore, graphic a) shows a center line 215 of a lane 249 of the road 257. The center line 215 describes the course of a cen-tral position of the particular lane 249. The center line 215 is shown as a further item of sub-information of the landmark information and/or planning information 209. The center line 215 is shown as line information 237.

In graphic b), in addition to the center line 215 and the traffic sign 211, a relationship 255 between the center line 215 and the traffic sign 211 is also shown.

In this case, the center line 215 describes a possible route for vehicles on the particular lane 249. Depending on the particular traffic sign 211, the route can be influenced. For example, in the example shown in graphic b), the traffic sign 211 can be a right turn sign. The relationship 255 between the center line 215 and the traffic sign 211 in the form of the right-hand bend can be established by this.

In graphic c), another item of sub-information of the landmark information and/or planning information 209 is shown in the form of segment information 217. In graphic c), the course of the road 257 is divided into a first segment 259 and a second segment 261. In the first segment 259, the course of the road 257 is straight, while in the second segment 261, there is a split of the road 257 in the form of a right turn.

The corresponding segment information 217, in which the segmentation of the road 257 shown is defined, allows the corresponding courses of the center lines 215 to be taken into account. The segment information 217, which states, for example, that in one segment a straight course of the road exists and in another segment a road intersection and/or a branch of the road 257 exists, can be directly considered as relevant information for the trajectory planning of the journey of the vehicle along the road 257.

The landmark information and/or planning information 209 shown in graphics a) to c) represent direct orientation possibilities, i.e. landmarks in the form of the traffic signs 211 or road signs, and road markings 213 and planning-relevant information in the form of the center line 215, the relationship 255 and the segment information 217.

To take into account the shown landmark information and/or planning information 209 in the feature vectors 229, the landmark information and/or planning information 209 represented as point information 239 are considered as corresponding entries in a particular multidimensional feature vector 229.

The landmark information and/or planning information 209 represented as line information 237 are scanned by a scanning proce-dure and thereby converted into a plurality of items of point information 239, as shown in graphics a) to c) for the center line 215.

The line information 237 is scanned over a predefined region of the electronic road map 207, i.e. the corresponding line information 237 is scanned over a predefined length and converted into a plurality of items of point information 239.

The point information 239 correspondingly generated in this way of the landmark information 237 and/or planning information 209 originally represented as line information is subsequently taken into account as corresponding entries of a multidimensional sub-feature vector 233.

In this case, the particular items of line information 237 can be scanned in such a way that for each item of line information 237 taken into account, an identical number of items of point information 239 is determined.

By using the identical number of items of point information 239, by means of which the particular item of line information 237 can be represented, it can be achieved that the particular sub-feature vectors 233 each have a predefined identical dimension-ality. This enables the further processing of the correspond-ingly generated sub-feature vectors 233.

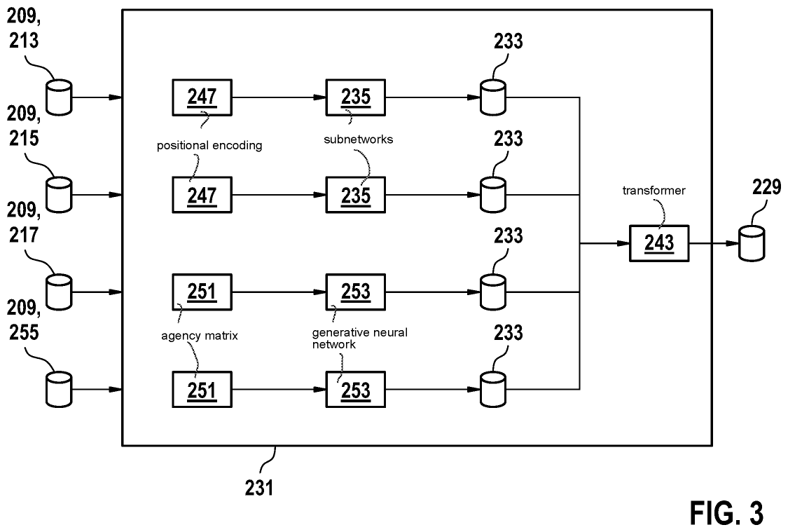

FIG. 3 is a schematic representation of a map encoder 231 of the onboard map generation system 203 according to one embodiment.

In the embodiment shown, the map encoder 231 comprises four sub-networks 235 which are configured to generate corresponding sub-feature vectors 233 on the basis of the four items of sub-information of the landmark information and/or planning information 209 shown in FIG. 2.

In the embodiment shown, two subnetworks 235 are designed as multilayer perceptrons (MLPs), and two subnetworks 235 as generative neural networks.

To generate a feature vector 229 on the basis of the multiple items of sub-information of the landmark information and/or planning information 209, the various items of sub-information in the form of the road marking 213, the center line 215, the segment information 217 and the relationship 255 between the center line 215 and the traffic sign 211 are each provided as individual items of sub-information as input data to the map encoder 231.

In the embodiment shown, positional encoding 247 is first performed for the road marking 213 and the center line 215, and subsequently the results of the positional encoding 247 are provided as input data to the respective subnetworks 235. The sub-networks 235 provide a corresponding sub-feature vector 233.

The segment information 217 and the relationship 255 are first each provided to an adjacency matrix 251, the results of which are then provided as input data to the generative neural network 253. This then generates a corresponding sub-feature vector 233.

Subsequently, the four different sub-feature vectors 233 generated for the four different items of sub-information are concatenated and provided to a transformer 243 of the map encoder 231. The transformer 243 then creates a common feature vector 229 on the basis of the four concatenated sub-feature vectors 233, which common feature vector comprises the four different items of sub-information.

The objective of the correspondingly configured map encoder 231 with the plurality of subnetworks 235 is to generate independent sub-feature vectors 233 of a predefined dimension k for the various items of sub-information in the form of the traffic sign 211, the road marking 213, the center line 215, the segment information 217 and the relationship 255.

For the items of sub-information represented as line information 237 such as the road marking 213 and the center line 215, a uniform number nₗᵢₙₑₛ of items of point information 239 is determined for each item of line information 237 of a uniform length.

In this case, the corresponding sub-feature vector 233 has a number of entries nₗᵢₙₑₛ×(kₚₒₛ+k_{feature}), where kₚₒₛ is a feature dimension created from the positional encoding 247, and k_{feature} is the feature dimension of the input feature. In the case of the road marking 213, k_{feature} is for example 4: wherein the four dimensions are formed from three-dimensional coordinate information and a particular type that defines the particular feature in the given example as a road marking 213.

With the subsequently executed subnetwork 235, which is designed as a multilayer perceptron MLP, and by performing suitable re-shaping, the corresponding sub-feature vector 233 with the pre-defined dimension k is generated.

For the traffic signs 211 represented as point information 239, an input vector of dimension kₚₒₛ+k_{feature} is first generated, wherein, in this case, k_{feature} is also 4: again the three-dimensional coordinate information and the type of the particular feature, in this case the traffic sign 211 in the form of the road sign.

By using the subnetwork 235 implemented as an MLP, the k-dimensional sub-feature vector 233 is generated for the point information 239 of the traffic sign 211 in the form of a road sign.

For the segment information 217 and the relationships 255 between the traffic signs 211 and the lanes or center lines 215, the segment information 217 and relationships 255 are first parameterized by the adjacency matrices 251.

The parameterized solutions then serve as input for the generative neural networks 253. This in turn generates the k-dimensional sub-feature vector 233.

The correspondingly described graph approach by executing the parameterization using the adjacency matrices 251 and the subse-quent execution of the generative neural networks 253 can be executed according to Li et al. (T. Li, P. Jia, B. Wang, L. Chen, K. Jiang, J. Yan, and H. Li, “Lanesegnet: Map learning with lane segment perception for autonomous driving,” arXiv preprint arXiv:2312.16108, 2023).

Subsequently, all generated sub-feature vectors 233 are concatenated, and a corresponding n_{planning}×k-dimensional feature vector 229 is generated, where n_{planning} represents the number of different items of sub-information of the landmark information and/or planning information 209 taken into account.

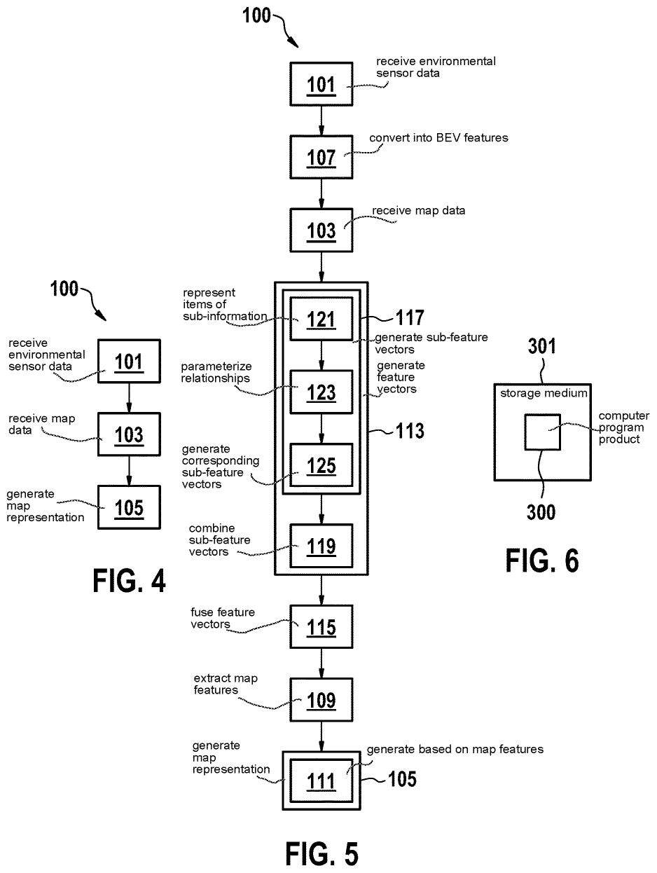

FIG. 4 is a flowchart of a method 100 for generating a map representation 200 for a vehicle according to one embodiment.

To generate a map representation 200 for a vehicle, the onboard map generation system 203 first receives environmental sensor data 201 of the at least one environmental sensor of the vehicle. (Step 101). In this case, the environmental sensor data 201 at least partially represent the environment of the vehicle.

In a further method step 103, the onboard map generation system 203 receives map data 205 of an electronic road map 207. The electronic road map 207 serves as a map prior and represents the traffic infrastructure within the environment of the vehicle. The map data 205 comprise at least landmark information and/or planning information 209.

In a further method step 105, the map representation 200 is generated by the onboard map generation system 203 on the basis of the environmental sensor data 201 and the landmark information and/or planning information 209 of the map data 205 of the electronic road map 207.

The map representation 200 comprises the landmark information and/or planning information 209. Here, the generation of the map representation 200 is executed as an onboard map generation and is performed during operation of the vehicle.

FIG. 5 is a further flowchart of the method 100 for generating a map representation 200 for a vehicle according to a further embodiment.

The embodiment shown is based on the embodiment in FIG. 4 and comprises all the method steps described there.

In the embodiment shown, in a method step 107, the received environmental sensor data 201 are converted into bird's-eye-view features 219 by a transformer 243 of the BEV backbone 221 of the onboard map generation system 203.

In a further method step 113, the feature vectors 229 are generated by the map encoder 231 of the onboard map generation system 203 on the basis of the landmark information and/or planning information 209 of the map data 205 of the electronic road map 207.

For this purpose, in a method step 117, a sub-feature vector 233 is generated for each of the items of sub-information of the landmark information and/or planning information 209.

To this end, in a method step 121, the items of sub-information of the landmark information and/or planning information 209 represented as line information 237 are each represented as a plurality of items of point information 239, and the sub-feature vectors 233 are generated as multidimensional vectors, wherein the dimension of a sub-feature vector 233 corresponds to a sum of the number of items of point information 239 and a number of features of the particular item of sub-information.

In a further method step 123, the relationships 255 between seg-ments/segment information 217 and/or the relationships 255 between traffic signs 211 and/or lanes 249 or center lines 215 are parameterized by executing adjacency matrices 251.

In a further method step 125, corresponding sub-feature vectors 233 are generated on the basis of the parameterizations by executing generative neural networks 253.

In a further method step 119, the sub-feature vectors 233 are combined by the map encoder 231 to form a total feature vector 229.

In a further method step 115, the feature vectors 229 are fused with the environmental sensor data 201.

In a further method step 109, map features 223 are extracted, on the basis of the bird's-eye-view features 219, by a map head 225 of the onboard map generation system 203.

In a further method step 111, the map representation 200 is generated on the basis of the map features 223 by a map prediction module 227 of the onboard map generation system 203.

FIG. 6 is a schematic representation of a computer program product 300 comprising commands that, when the program is executed by a data processing unit, cause the data processing unit to carry out the method 100 for generating a map representation 200 for a vehicle.

In the embodiment shown, the computer program product 300 is stored on a storage medium 301. The storage medium 301 can be any storage medium from the related or prior art.

What is claimed is:

1. A computer-implemented method for generating a map representation for a vehicle, comprising:
receiving environmental sensor data of at least one environmental sensor of the vehicle by an onboard map generation system, wherein the environmental sensor data at least partially represent the environment of the vehicle;
receiving map data of an electronic road map by the onboard map generation system, wherein the map data at least partially represent the traffic infrastructure within the environment of the vehicle, and wherein the map data includes landmark information and/or planning information for trajectory planning in relation to the traffic infra-structure within the environment of the vehicle; and
generating the map representation of the environment of the vehicle based on the environmental sensor data and the landmark information and/or planning information of the map data by the onboard map generation system, wherein the map representation includes the landmark information and/or planning information.

2. The method according to claim 1, wherein the landmark information and/or planning information include at least one item of sub-information from the following list: traffic sign, road marking, center line, segment information.

3. The method according to claim 1, wherein the environmental sensor data include image data and/or video data.

4. The method according to claim 1, wherein the method further comprises:
converting the environmental sensor data into bird's-eye-view (BEV) features by a transformer of a BEV backbone of the onboard map generation system;
extracting map features based on the BEV features by a map head of the onboard map generation system; and
generating the map representation based on the map features by a map prediction module of the onboard map generation system.

5. The method according to claim 4, further comprising:
generating feature vectors based on the landmark information and/or planning information of the map data by a map encoder of the onboard map generation system; and
fusing the feature vectors with the environmental sensor data.

6. The method according to claim 5, wherein the fusion of the feature vectors with the environmental sensor data takes place in the map head.

7. The method according to claim 5, wherein the fusion is effected via a cross-attention mechanism between the feature vectors and the BEV features of the environmental sensor data.

8. The method according to claim 5, wherein the fusion of the feature vectors with the environmental sensor data takes place in the transformer of the BEV backbone.

9. The method according to claim 5, wherein the feature vectors are fused with the BEV features generated by the BEV backbone via a cross-attention mechanism.

10. The method according to claim 5, wherein the landmark information and/or planning information include at least one item of sub-information from the following list: traffic sign, road marking, center line, segment information, and wherein the generation of the feature vectors includes:
generating a sub-feature vector for each of the items of sub-information of the landmark information and/or planning information; and
merging the sub-feature vectors to form a total feature vector by the map encoder.

11. The method according to claim 10, wherein the map encoder includes a plurality of artificial subnetworks and generative neural networks, wherein each subnetwork of the plurality of artificial subnetworks and each generative neural network of the generative neural networks is configured to generate a corresponding sub-feature vector based on the map data for an item of sub-information of the landmark information and/or planning information.

12. The method according to claim 10, wherein the road marking and the center line are each configured as line information, wherein the traffic sign is configured as point information, and wherein the generation of the sub-feature vectors includes:
representing the line information as a plurality of items of point information and generating the sub-feature vectors as multidimensional vectors, wherein a dimension of a sub-feature vector corresponds to a sum of a number of items of point information and a number of features of the respective item of sub-information;
parameterizing relationships between at least one of: (i) segment information, (ii) traffic signs, (iii) lanes, or (iv) center lines, using adjacency matrices; and
generating the sub-feature vector based on the parameterizations by a generative neural network.

13. A computing unit configured to generate a map representation for a vehicle, the computing unit configured to:
receive environmental sensor data of at least one environmental sensor of the vehicle by an onboard map generation system, wherein the environmental sensor data at least partially represent the environment of the vehicle;
receive map data of an electronic road map by the on-board map generation system, wherein the map data at least partially represent the traffic infrastructure within the environment of the vehicle, and wherein the map data includes landmark information and/or planning information for trajectory planning in relation to the traffic infrastructure within the environment of the vehicle; and
generate the map representation of the environment of the vehicle based on the environmental sensor data and the landmark information and/or planning information of the map data by the onboard map generation system, wherein the map representation includes the landmark information and/or planning information.

14. A non-transitory storage medium on which is stored a computer program including commands for generating a map representation for a vehicle, the commands, when executed by a data processor, causing the data processor to perform the following steps:
receiving environmental sensor data of at least one environmental sensor of the vehicle by an onboard map generation system, wherein the environmental sensor data at least partially represent the environment of the vehicle;
receiving map data of an electronic road map by the onboard map generation system, wherein the map data at least partially represent the traffic infrastructure within the environment of the vehicle, and wherein the map data includes landmark information and/or planning information for trajectory planning in relation to the traffic infra-structure within the environment of the vehicle; and
generating the map representation of the environment of the vehicle based on the environmental sensor data and the landmark information and/or planning information of the map data by the onboard map generation system, wherein the map representation includes the landmark information and/or planning information.
